(19) United States
(12) Patent Application Publication
(10) Pub. No.: US 2002/0073830 A1
(43) Pub. Date: Jun. 20, 2002

(54) Balanced pickup for stringed instruments

(76) Inventor: John Elliot Petherick, Suffolk (GB)

Correspondence Address: Frank Chau, F. CHAU & ASSOCIATES, LLP, 1900 Hempstead Turnpike, Suite 501, East Meadow, NY, 11554, US

(21) Appl. No.: 09/954,481

(22) Filed: Sep. 17, 2001

(30) Foreign Application Priority Data
Sep. 18, 2000 (GB) 0022882.5

(51) Int. Cl. G10H 3/18

(52) U.S. Cl. 84/726

(57) ABSTRACT

A balanced pickup for a stringed instrument comprises first and second windings wound in opposite senses from a common point. A switch may be provided for configuring the pickup for both balanced and single-ended output. Also, a balanced lead incorporating a balun is described.

### FIELD OF THE INVENTION

The present invention relates to a balanced pickup for a stringed instrument such as an electric guitar or an electric mandolin.

### BACKGROUND TO THE INVENTION

Conventionally, pickups for electric stringed instruments have been made by winding enamelled copper wire around, for example, six or four solid cylindrical magnets, which sit beneath respective strings. When a sting vibrates, a small electric current is generated in the coil wound around the magnets and this is then amplified.

A problem with conventional pickups is that they have poor noise rejection. One solution to this problem is the so called “humbucker” pickup.

### SUMMARY OF THE INVENTION

According to the present invention, there is provided a pickup for an electric stringed instrument comprising magnetic field generating means, e.g. one or more permanent magnets, and sensing coil means wound about the magnetic field generating means, the sensing coil means comprising first and second portions wound in opposite senses from a common ground.

According to the present invention, there is also provided a stringed instrument having a pickup according to the present invention and including a stereo socket wherein said common ground is connected to the ground contact of said socket and the non-ground connected ends of said portions are connected respectively to the left, e.g. tip, and right, e.g. ring, signal contacts of said socket.

Thus, the present invention provides a pickup producing a balanced output and having improved hum and noise rejection.

According to the present invention, there is further provided a stringed instrument including a pickup comprising magnetic field generating means and first and second coils wound about the magnetic field generating means, switching means and a stereo socket, wherein the switching means is configured such that:

in a first condition, respective first ends of the first and second coils are connected to a common ground comprising the ground terminal of said socket such that they generate a differential signal between their second ends in response to vibration of a string and their second ends are connected to the left and right terminals of said socket respectively; and

in a second condition, the first end of the first coil and the second end of the second coil are connected to said common ground and the second end of the first coil and the first end of the second coil are both connected to either the left or right terminal of said socket. Consequently, such a stringed instrument may be used with both balanced and unbalanced leads so that amplifiers having balanced inputs can be used as well as conventional amplifiers with unbalanced inputs.

Conveniently, the switching means may consist of a double pole changeover switch.

Preferably, a first tone control circuit is provided for affecting signals to the left terminal of said socket and a second tone control circuit is provided for affecting signals to the right terminal of said socket. The tone control circuits may be active or passive.

According to the present invention, there is further provided a screened twin-core lead having a stereo plug at one end and a mono plug at the other end and a balun located in or close to the mono plug for converting a balanced signal conveyed by the two cores of the lead into an unbalanced signal for transmission via the mono plug. Consequently, the advantages of a balanced signals can be largely obtained even when the amplifier use has an unbalanced input.

A lead according to the present invention is particularly useful for connecting a stringed instrument according to the present invention to an amplifier having an unbalanced signal input port.

### BRIEF DESCRIPTION OF THE DRAWINGS

FIG. 1 is a front view of an electric guitar according to the present invention;

FIG. 2 is an exploded view of a pickup according to the present invention;

FIG. 3 illustrates the circuitry of the guitar of FIG. 1 is a first configuration;

FIG. 4 illustrates the circuitry of the guitar of FIG. 1 is a second configuration;

FIG. 5 illustrates the circuitry of the guitar of FIG. 1 is a third configuration;

FIG. 6 illustrates one end of a lead according to the present invention; and

FIG. 7 shows a the guitar of FIG. 1 connected to an amplifier by the lead of FIG. 6.

### DETAILED DESCRIPTION OF PREFERRED EMBODIMENT

An embodiment of the present invention will now be described, by way of example, with reference to the accompanying drawings.

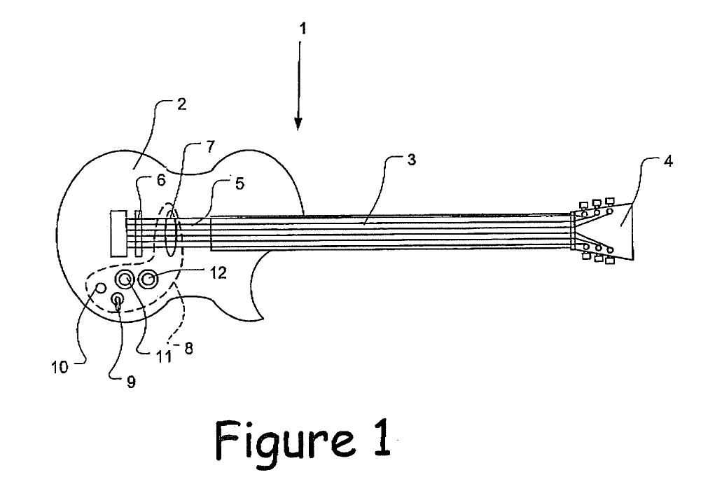

Referring to FIG. 1, an electric guitar 1 comprises a body 2, a neck 3 and a head 4. Six strings 5 extend from a bridge 6, mounted to the body 2, to the head 4. A pickup 7 is mounted in the body 2 between the bridge 6 and the neck 3 for detecting vibration of the strings 5. An electrically shielded cavity 8 is formed in the body 2 and contains the guitar's wiring and electronic components. A doublepole changeover switch 9, a stereo 1/4 inch jack socket 10, a volume control 11 and a tone control 12 are mounted in the body 2 and project through into the cavity 8.

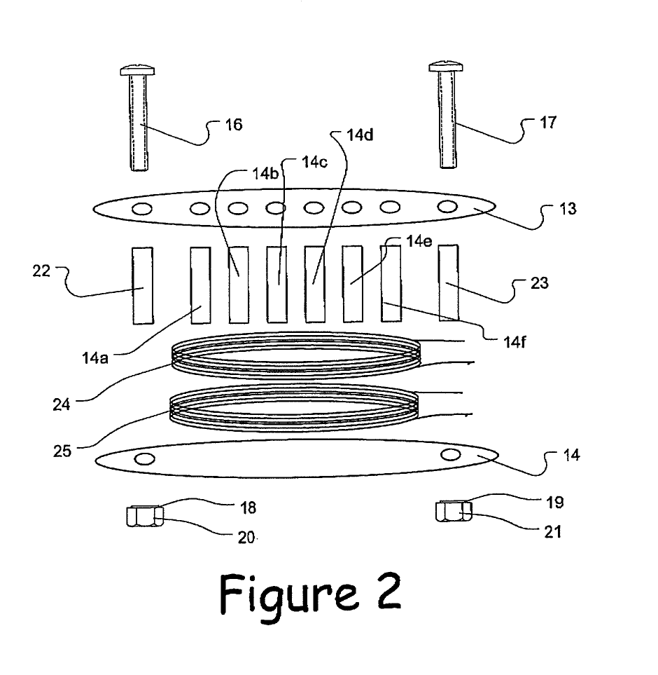

Referring to FIG. 2, the pickup 7 comprises insulating top and bottom plates 13, 14. Six small cylindrical permanent magnets 15a, . . . , 15f are clamped between the top and bottom plates 13, 14 by screws 16, 17, washers 18, 19 and nuts 20, 21. The magnets 15a, . . . , 15f project slightly through holes provided in the top plate 13. The screws 16, 17 pass through respective insulating spacers 22, 23. First and second coils 24, 25 are wound around the magnets 15a, . . . , 15f. The coils 24, 25 are shown separately for clarity but are preferably wound together so that they experience the same magnetic field. The coils 24, 25 are wound from 42 awg enamel coated copper wire and each coil 24, 25 consists of 200 to 500 turns. Both coils 24, 25 have the same number of turns. The coils 24, 25 are wrapped in metallic foil (not shown) which is connected to the ground end of the first coil 24.

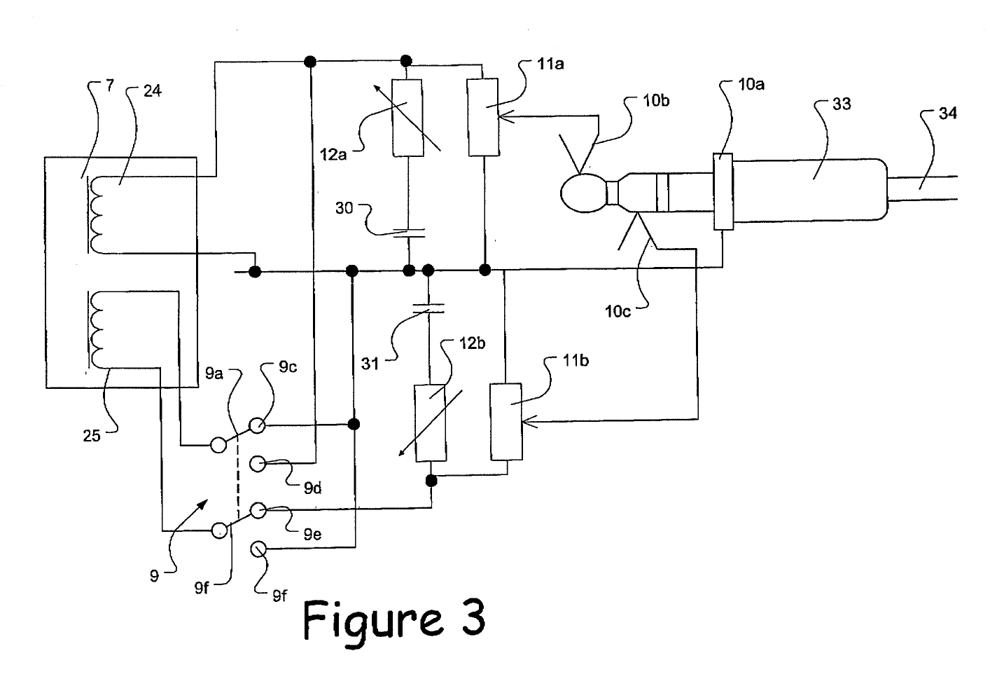

Referring to FIG. 3, a first end of the first coil 24, i.e. the end connected to the foil wrapping the coils 24, 25, is connected to the ground contact 10a of the jack socket 10. A first potentiometer 11a, forming part of the volume. control 11, is connected across the first coil 24 and its wiper is connected to a first signal terminal 10b of the jack socket 10. A first variable resistor 12a, forming part of the tone control 12, and a first capacitor 30 are connected in series and together are connected across the first winding 24.

The ends of the second coil 25 are connected to respective moving contacts 9a, 9b of the double pole changeover switch 9. First and second fixed contacts 9c, 9d of the first pole are connected respectively to the ground 10a terminal of the jack socket 10 and the second end of the first coil 24. The second fixed contact 9f of the second pole is connected to the ground terminal 10a of the jack socket 10. A second potentiometer 11b, also forming part of the volume control 11, is connected between the first fixed terminal 9e of the second pole of the double pole changeover switch 9 and the ground terminal of the jack socket 10. The wiper of the second potentiometer 11b is connected to the second signal terminal 10c of the jack socket, A second variable resistor 12b, also forming part of the tone control 12, and a second capacitor 31 are connected in series between the first fixed contact 9e of the second pole of the changeover switch 8 and the ground terminal 10a of the jack socket 10.

The first and second potentiometers 11a, 11b are have the same values and are ganged so that their wipers move together. The first and second variable resistors 12a, 12b have the same values and are also ganged so that operation of the tone control 12 changes the resistance of both variable resistors 12a, 12b in the same manner. The variable resistors 12a, 12b and their associated capacitors 30, 31 form conventional tone control circuits.

A stereo jack plug 33 is plugged into the jack socket 10. The jack plug 33 is connected to a screened twin-core lead 34.

With the changeover switch 9 in the state shown in FIG. 3, the first and second coils 24, 25 are connected so that they produce equal and opposite, i.e. differential, currents in response to vibration of a string 5. The output from the first coil 24 is supplied to the first signal terminal 10a of the jack socket 10 via the first potentiometer 11a. The output of the second coil 25 is supplied to the second signal terminal 10b of the jack socket 10 via the second potentiometer. Consequently, a balanced signal is supplied to the two cores of the lead 34.

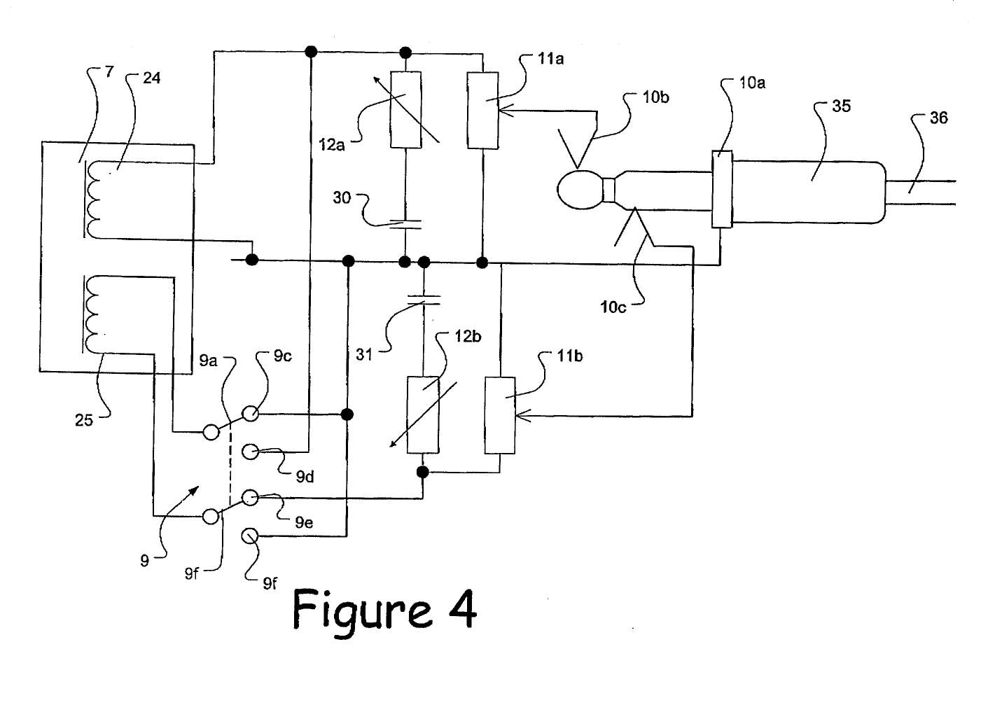

Referring to FIG. 4, the stereo jack plug 33 has been replaced by a mono jack plug 35 terminating a single core lead 36. As a result the second signal terminal 10c and the ground terminal 10a of the jack socket 10 are shorted by the ground terminal of the mono jack plug 35. Consequently, no output is taken from the second coil 25. However, the output of the first coil 24 is still supplied via the first potentiometer to the first signal terminal 10a of the jack socket 10 and then to the signal terminal of the mono jack plug 35. Thus, even if the switch 9 were to be replaced with permanent connections, the pickup according to the present invention would be useable with a unbalanced lead and amplifier.

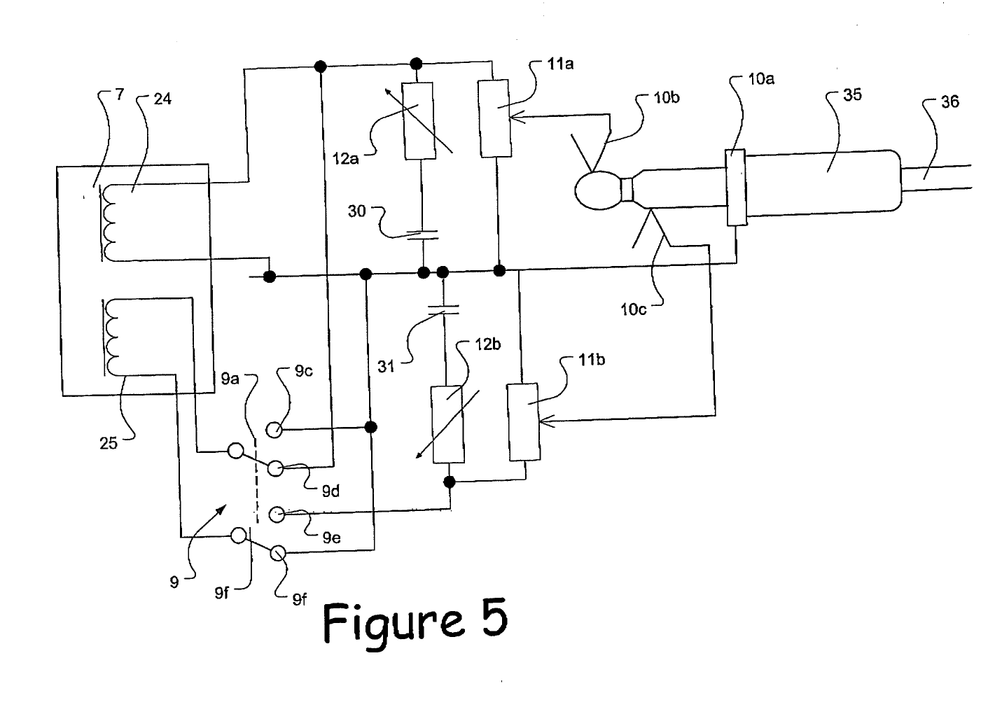

Referring to FIG. 5, the mono jack plug 35 remains. However, the changeover switch 9 has been thrown. This has the effect of connecting the first and second coils 24, 25 in parallel with the windings in the same sense. The outputs of the coils 23, 24 are therefore in phase. The combined output is fed to the first signal terminal 9b of the jack socket 9 via the first potentiometer 10a. The second signal terminal 9c, the second potentiometer 10b, the second variable resistor 11b and the second capacitor 35 are now isolated from the second coil 25 other than via the ground terminal of the mono jack plug 35.

The parallel arrangement of the coils 24, 25 reduces the source impedance of the pickup which is advantageous for reducing noise in the guitar's output.

Although the guitar 1 can be used with a mono jack plug 35 and a single-core lead 36, it is desirable to use a balanced lead, e.g. a screened twin-core lead.

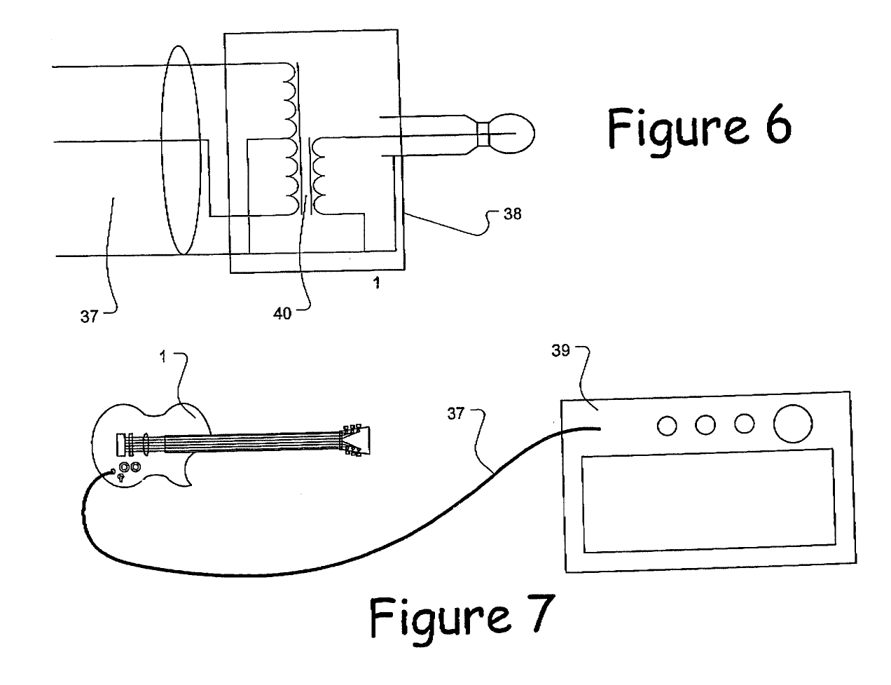

Referring to FIGS. 6 and 7, a screened twin-core lead 37 has a stereo jack plug 34 (see FIG. 3) at one end which is plugged into the guitar 1. The other end of the lead 37 has a specially adapted mono jack plug 38 which is plugged into a mono jack socket of a conventional guitar amplifier 39.

The mono jack plug 38 contains a balun 40 for converting the balanced signal from the guitar 1 into an unbalanced signal for the amplifier 40.

It will be appreciated that many modifications may be made to the embodiment described above without departing from the spirit and scope of the claim appended hereto. For example) the passive tone and volume control circuits may be replaced by active electronics which may be powered by a battery in the guitar or, possibly, by power supplied via the signal lead as in the case of electret microphones.

What is claimed is:

1. A pickup for an electric stringed instrument comprising magnetic field generating means and sensing coil means wound about the magnetic field generating means, the sensing coil means comprising first and second portions wound in opposite senses from a common ground.

2. A stringed instrument including a pickup according to claim 1.

3. A stringed instrument according to claim 2, including a stereo socket, wherein said common ground is connected to the ground contact of said socket and the non-ground connected ends of said portions are connected respectively to the left and right signal contacts of said socket.

4. A stringed instrument including a pickup comprising magnetic field generating means and first and second coils wound about the magnetic field generating means, switching means and a stereo socket, wherein the switching means is configured such that:
in a first condition, respective first ends of the first and second coils are connected to a common ground comprising the ground terminal of said socket such that they generate a differential signal between their second ends in response to vibration of a string and their second ends are connected to the left and right terminals of said socket respectively; and
in a second condition, the first end of the first coil and the second end of the second coil are connected to said common ground and the second end of the first coil and the first end of the second coil are both connected to either the left or right terminal of said socket.

5. A stringed instrument according to claim 4, wherein the switching means consists of a double pole changeover switch.

6. A string instrument according to claim 4, including a first tone control circuit for affecting signals to the left terminal of said socket and a second tone control circuit for affecting signals to the right terminal of said socket.

7. A string instrument according to claim 5, including a first tone control circuit for affecting signals to the left terminal of said socket and a second tone control circuit for affecting signals to the right terminal of said socket.

8. A screened twin-core lead having a stereo plug at one end and a mono plug at the other end and a balun located in or close to the mono plug for converting a balanced signal conveyed by the two cores of the lead into an unbalanced signal for transmission via the mono plug.

9. A system comprising:
a stringed instrument including:
magnetic field generating means,
sensing coil means wound about the magnetic field generating means
and comprising first and second portions wound in opposite senses
from a common ground, and
a stereo socket, and
a screened twin-core lead including:
a stereo plug at one end,
a mono plug at the other end, and
a balun located in or close to the mono plug for converting a
balanced signal conveyed by the two cores of the lead into an
unbalanced signal for transmission via the mono plug,
wherein said common ground is connected to the ground contact of said socket and the non-ground connected ends of said portions are connected respectively to the left and right signal contacts of said socket and a lead according to claim 7, the stereo plug of the lead being plugged into the stereo socket of the stringed instrument.

10. A system comprising:
a stringed instrument including:
a pickup comprising magnetic field generating means and first and
second coils wound about the magnetic field generating means;
switching means; and
a stereo socket, and
a screened twin-core lead including:
a stereo plug at one end,
a mono plug at the other end, and
a balun located in or close to the mono plug for converting a
balanced signal conveyed by the two cores of the lead into an
unbalanced signal for transmission via the mono plug,
wherein the switching means is configured such that:
in a first condition, respective first ends of the first and second coils are connected to a common ground comprising the ground terminal of said socket such that they generate a differential signal between their second ends in response to vibration of a string of said instrument and their second ends are connected to the left and right terminals of said socket respectively, and in a second condition, the first end of the first coil and the second end of the second coil are connected to said common ground and the second end of the first coil and the first end of the second coil are both connected to either the left or right terminal of said socket.

11. A system according to claim 10, wherein the switching means consists of a double pole changeover switch.

12. A system according to claim 11, wherein said instrument includes a first tone control circuit for affecting signals to the left terminal of said socket and a second tone control circuit for affecting signals to the right terminal of said socket.

13. A system according to claim 10, wherein said instrument includes a first tone control circuit for affecting signals to the left terminal of said socket and a second tone control circuit for affecting signals to the right terminal of said socket.
